(19) United States
(12) Patent Application Publication
(10) Pub. No.: US 2011/0158189 A1
(43) Pub. Date: Jun. 30, 2011

(54) Methods and Apparatus for Multi-Transmitter Collaborative Communications Systems

(75) Inventors: Ping-Heng Kuo, Pingtung City (TW); Chih-Yu Chen, Hsinchu City (TW); Pang-An Ting, Fongyuan City (TW); Hsiao-Lan Chiang, Miaoli City (TW)

(73) Assignee: Industrial Technology Research Institute

(21) Appl. No.: 12/874,703

(22) Filed: Sep. 2, 2010

Related U.S. Application Data
(60) Provisional application No. 61/290,881, filed on Dec. 29, 2009.
(60) Provisional application No. 61/294,286, filed on Jan. 12, 2010.

(51) Int. Cl. H04W 4/00

(52) U.S. Cl. 370/329

(57) ABSTRACT

Method and apparatus for reception of multi-input multi-output (MIMO) transmission in a wireless communication system including a plurality of base stations. The method includes receiving, by a receiving device, one or more media access control (MAC) messages including a plurality of identifiers of neighboring base stations, and receiving, by the receiving device, a bistream including a plurality of bits, each bit representing one base station of the plurality of base stations. The method also includes determining, by the receiving device, at least one of the plurality of identifiers of neighboring base stations included in the one or more received MAC messages based on the received bitmap.

### PRIORITY

This application claims the benefit of priority of U.S. Provisional Application No. 61/290,881, filed Dec. 29, 2009, and the benefit of priority of U.S. Provisional Application No. 61/294,286, filed Jan. 12, 2010, both of which are incorporated by reference herein in their entirety for any purpose.

### TECHNICAL FIELD

The present disclosure relates generally to methods and devices for communication and, more particularly, to methods and apparatuses for multi-transmitter collaborative wireless communication systems.

### BACKGROUND

Wireless communication systems allow wireless devices to communicate without the necessity of wired connections. Because wireless systems have become so integrated into daily life, there is a growing demand for wireless communication systems that support multimedia services such as speech, audio, video, file and web downloading, and the like. Various wireless communication protocols and transmission control mechanisms have been developed to meet the growing demands of multimedia services over wireless communication networks and to improve the performance of these multimedia services.

In wireless communication systems, multiple-input and multiple-output (MIMO), a form of smart antenna technology, involves the use of multiple antennas at both the transmitter and receiver to improve communication performance. Originally, MIMO technology schemes were defined as point-to-point communication systems having multiple antenna elements at both the transmitter and receiver. More recently, however, MIMO technology schemes have been extended to apply to more complicated scenarios such as space division multiple access (SDMA) and cooperative communications. This extension is possible because the cooperative processing available among multiple terminals, each terminal having a single antenna, can be deemed as a single transmitting or receiving node with a virtual antenna array.

While MIMO may offer significant increases in data throughput and transmission range without additional bandwidth requirements or transmission power, there are many challenges that exist in implementation. In particular, many operational procedures may be too complex to implement in practical systems, and the latency caused by these operational procedures may lead to degradation of resultant performance.

The disclosed embodiments are directed to overcoming one or more of the problems set forth above.

### SUMMARY

In one exemplary embodiment, the present disclosure is directed to a method for multi-input multi-output (MIMO) transmission in a wireless communication system including a plurality of base stations, comprising: receiving, by a receiving device, one or more media access control (MAC) messages including a plurality of identifiers of neighboring base stations; receiving, by the receiving device, a bitmap including a plurality of bits, each bit representing one base station of the plurality of base stations; and determining, by the receiving device, at least one of the plurality of identifiers of neighboring base stations included in the one or more received MAC messages based on the received bitmap.

In another exemplary embodiment, the present disclosure is directed to an apparatus for MIMO transmission in a wireless communication system including a plurality of base stations, the apparatus comprising: at least one memory to store data and instructions; and at least one processor configured to access the at least one memory and, when executing the instructions, to: receive one or more media access control (MAC) messages including a plurality of identifiers of neighboring base stations; receive a bitmap including a plurality of bits, each bit representing one base station of the plurality of base stations; and determine at least one of the plurality of identifiers of neighboring base stations included in the one or more received MAC messages based on the received bitmap.

In one exemplary embodiment, the present disclosure is directed to a method for MIMO transmission in a wireless communication system including a plurality of base stations, comprising: determining, by one base station of the plurality of base stations, a user subset from a user subsets list; searching, by the one base station, a codeword combinations list to identify a codeword combination having a desired signal-to-interference noise ratio (SINR) based on the determined user subset; storing, by the one base station, the desired SINR as a maximum SINR (SINRₘₐₓ); iteratively processing, by the one base station, at least one of the user subsets list and the codeword combinations list to identify a final user subset and final codeword combination; outputting, by the one base station, the identified final user subset and the final codeword combination; and constructing, by the one base station, a precoder based on the output final user subset and final codeword combination.

In another exemplary embodiment, the present disclosure is directed to an apparatus for MIMO transmission in a wireless communication system including a plurality of base stations, the apparatus comprising: at least one memory to store data and instructions; and at least one processor configured to access the at least one memory and, when executing the instructions, to: determine a user subset from a user subsets list; search a codeword combinations list to identify a codeword combination having a desired signal-to-interference noise ratio (SINR) based on the determined user subset; store the desired SINR as a maximum SINR (SINRₘₐₓ); iteratively process at least one of the user subsets list and the codeword combinations list to identify a final user subset and final codeword combination; output the identified final user subset and the final codeword combination; and construct a precoder based on the output final user subset and final codeword combination.

In one exemplary embodiment, the present disclosure is directed to a method for MIMO transmission in a wireless communication system including a plurality of base stations, comprising: determining, by a receiving device, a number Ng of generation bit streams; determining, by the receiving device, a number Np of population bit streams; generating, by the receiving device, a plurality of parent bit streams; iteratively processing, by the receiving device, through the plurality of parent bit streams for Ng times, including: calculating, by the receiving device, a utility function associated with each of the plurality of parent bit streams, iteratively processing, by the receiving device, through the plurality of parent bit streams for Np times, including: selecting, by the receiving device, two bit streams of the plurality of parent bit streams, and performing, by the receiving device, a cross-over operation based on the selected two bit streams to generate at least one child bit stream, and identifying, by the receiving device, an additional two bit streams of the plurality of parent bit streams to form a plurality of next generation bit streams, and calculating, by the receiving device, a utility function associated with each bit stream of the plurality of next generation bit streams; identifying, by the receiving device, at least one bit stream of the plurality of next generation bit streams; and performing, by the receiving device, a precoder search based on the at least one bit stream of the plurality of next generation bit streams.

In another exemplary embodiment, the present disclosure is directed to an apparatus for MIMO transmission in a wireless communication system including a plurality of base stations, the apparatus comprising: at least one memory to store data and instructions; and at least one processor configured to access the at least one memory and, when executing the instructions, to: determine a number Ng of generation bit streams; determine a number Np of population bit streams; generate a plurality of parent bit streams; iteratively process through the plurality of parent bit streams for Ng times: calculate a utility function associated with each of the plurality of parent bit streams, iteratively process through the plurality of parent bit streams for Np times, including: select two bit streams of the plurality of parent bit streams, and perform a cross-over operation based on the selected two bit streams to generate at least one child bit stream, and identify an additional two bit streams of the plurality of parent bit streams to form a plurality of next generation bit streams, and calculate a utility function associated with each bit stream of the plurality of next generation bit streams; identify at least one bit stream of the plurality of next generation bit streams; and perform a precoder search based on the at least one bit stream of the plurality of next generation bit streams.

In one exemplary embodiment, the present disclosure is directed to a method for MIMO transmission in a wireless communication system including a plurality of base stations, comprising: determining, by a receiving device, for a first base station of the plurality of base stations, a first plurality of candidate codewords included in a codebook; determining, by the receiving device, a second plurality of candidate codewords for a second base station of the plurality of base stations based on the identified first plurality of codewords; comparing, by the receiving device, the codewords in the second plurality of candidate codewords to identify one codeword of the first plurality of candidate codewords; determining, by the receiving device, an updated second plurality of candidate codewords for the second base station based on the comparison of the codewords in the second plurality of candidate codewords; determining, by the receiving device, a third plurality of candidate codewords for a third base station of the plurality of base stations based on the updated second plurality of codewords; comparing, by the receiving device, the codewords in the third plurality of candidate codewords to identify one codeword of the second plurality of candidate codewords; and determining, by the receiving device, a combination of precoder codewords based on the identified one codeword of the first plurality of candidate codewords and the identified one codeword of the second plurality of candidate codewords.

In another exemplary embodiment, the present disclosure is directed to an apparatus for MIMO transmission in a wireless communication system including a plurality of base stations, the apparatus comprising: at least one memory to store data and instructions; and at least one processor configured to access the at least one memory and, when executing the instructions, to: determine, for a first base station of the plurality of base stations, a first plurality of candidate codewords included in a codebook; determine a second plurality of candidate codewords for a second base station of the plurality of base stations based on the identified first plurality of codewords; compare the codewords in the second plurality of candidate codewords to identify one codeword of the first plurality of candidate codewords; determining, by the receiving device, an updated second plurality of candidate codewords for the second base station based on the comparison of the codewords in the second plurality of candidate codewords; determine a third plurality of candidate codewords for a third base station of the plurality of base stations based on the updated second plurality of codewords; compare the codewords in the third plurality of candidate codewords to identify one codeword of the second plurality of candidate codewords; and determine a combination of precoder codewords based on the identified one codeword of the first plurality of candidate codewords and the identified one codeword of the second plurality of candidate codewords.

### BRIEF DESCRIPTION OF THE DRAWINGS

FIG. 1a is a diagram illustrating multiple-input multiple-output (MIMO) communication in an exemplary wireless communication system, consistent with certain disclosed embodiments;

FIG. 1b is a diagram illustrating MIMO communication in an exemplary wireless communication system, consistent with certain disclosed embodiments;

FIG. 2a is a diagram of an exemplary base station (BS), consistent with certain disclosed embodiments;

FIG. 2b is a diagram of an exemplary receiving device (RD), consistent with certain disclosed embodiments;

FIG. 3 is a flowchart illustrating an exemplary MIMO transmission and reception, consistent with certain disclosed embodiments;

FIG. 4 is a flowchart illustrating a user and precoder selection algorithm, consistent with certain disclosed embodiments;

FIG. 5a is a diagram illustrating MIMO transmission and reception in an exemplary wireless communication system, consistent with certain disclosed embodiments;

FIG. 5b is a diagram illustrating MIMO transmission and reception in an exemplary wireless communication system, consistent with certain disclosed embodiments;

FIG. 5c is a diagram illustrating MIMO transmission and reception in an exemplary wireless communication system, consistent with certain disclosed embodiments;

FIG. 5d is a diagram illustrating MIMO transmission and reception in an exemplary wireless communication system, consistent with certain disclosed embodiments;

FIG. 5e is a diagram illustrating MIMO transmission and reception in an exemplary wireless communication system, consistent with certain disclosed embodiments;

FIG. 6 is a diagram illustrating MIMO transmission and reception in an exemplary wireless communication system, consistent with certain disclosed embodiments;

FIG. 7a is a flowchart illustrating an exemplary MIMO transmission and reception, consistent with certain disclosed embodiments;

FIG. 7b is a flowchart illustrating an exemplary MIMO transmission and reception, consistent with certain disclosed embodiments;

FIG. 8 is a diagram illustrating MIMO transmission and reception in an exemplary wireless communication system, consistent with certain disclosed embodiments;

FIG. 9 is a flowchart illustrating an exemplary MIMO transmission and reception, consistent with certain disclosed embodiments;

FIG. 10 is a flowchart illustrating an exemplary MIMO transmission and reception, consistent with certain disclosed embodiments; and

FIG. 11 is a diagram illustrating MIMO transmission and reception in an exemplary wireless communication system, consistent with certain disclosed embodiments.

### DETAILED DESCRIPTION

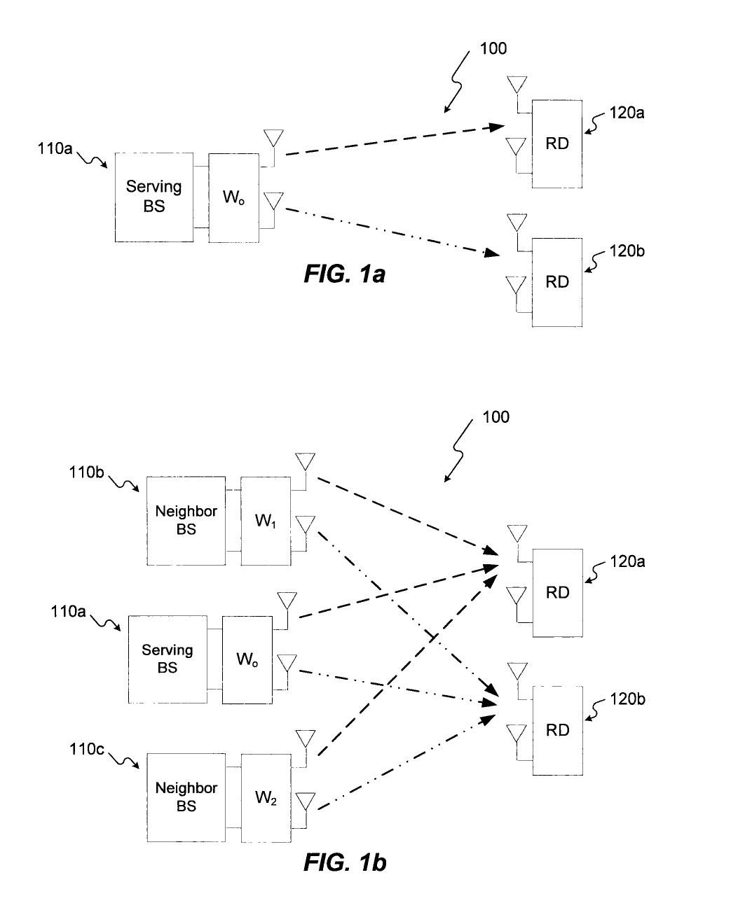

FIGS. 1a and 1b are diagrams of an exemplary multiple-input multiple-output (MIMO) wireless communication system 100. In one exemplary embodiment, wireless communication system 100 of FIGS. 1a and 1b may be based, for example, on the Worldwide Interoperability for Microwave Access (WiMAX), which is promulgated by the WiMax Forum, and is based on the IEEE 802.16 family of standards and technologies. In other embodiments, wireless communication system 100 of FIGS. 1a and 1b may be based, for example, on the 3^{rd} Generation Partnership Project (3GPP) family of standards and technologies. Wireless communication system 100 may be a multi-transmitter collaborative communication system. In some embodiments, wireless communication system 100 may be a multi-transmitter collaborative communication system having a single transmission device with multiple antenna elements. In other embodiments, wireless communication system 100 may be a multi-transmitter collaborative communication system having a set of transmission devices working in cooperation with each other. Unless otherwise specified, the present disclosure refers primarily to an embodiment in which a set of transmission devices work in cooperation with one another.

As shown in FIGS. 1a and 1b, wireless communication system 100 may include one or more transmission devices, referred to herein as base stations (BS) 110, e.g., BS 110a, BS 110b, and BS 110c, and one or more receiving devices (RD) 120, e.g., RD 120a and RD 120b. BS 110 may be any type of communication device configured to transmit and/or receive data and/or communications to and/or from one or more RDs 120 in wireless communication system 100, many of which are known in the art. In some embodiments, BS 110 may also be referred to as, for example, a Node-B, a base transceiver system (BTS), an access point, etc. In other embodiments, BS 110 may be a relay station, an intermediate node, an intermediary, or any type of mobile station. In one exemplary embodiment, BS 110 may have a broadcast/reception range within which BS 110 may wirelessly communicate with one or more one or more RDs 120. Broadcast ranges may vary due to power levels, location, and interference (physical, electrical, etc.).

In the embodiments of FIGS. 1a and 1b, wireless communication system 100 is a multi-user (MU) MIMO wireless communication system 100 in which multiple RDs 120 are concurrently served in the same time-frequency resource block, where the time-frequency resource block may be a basic scheduling unit in which both uplink and downlink signals are transmitted. In the embodiment of FIG. 1a, downlink signals may be sent from a single BS 110 to multiple RDs 120, e.g., RD 120a and RD 120b. In the embodiment of FIG. 1b, downlink signals may be sent from multiple BSs 110, e.g., BS 110a, BS 110b, and BS 110c, to one or more RDs 120, e.g., RD 120a and RD 120b. The embodiment of FIG. 1b may be referred to as a collaborative multiple-input multiple-output (CO-MIMO) wireless communication system.

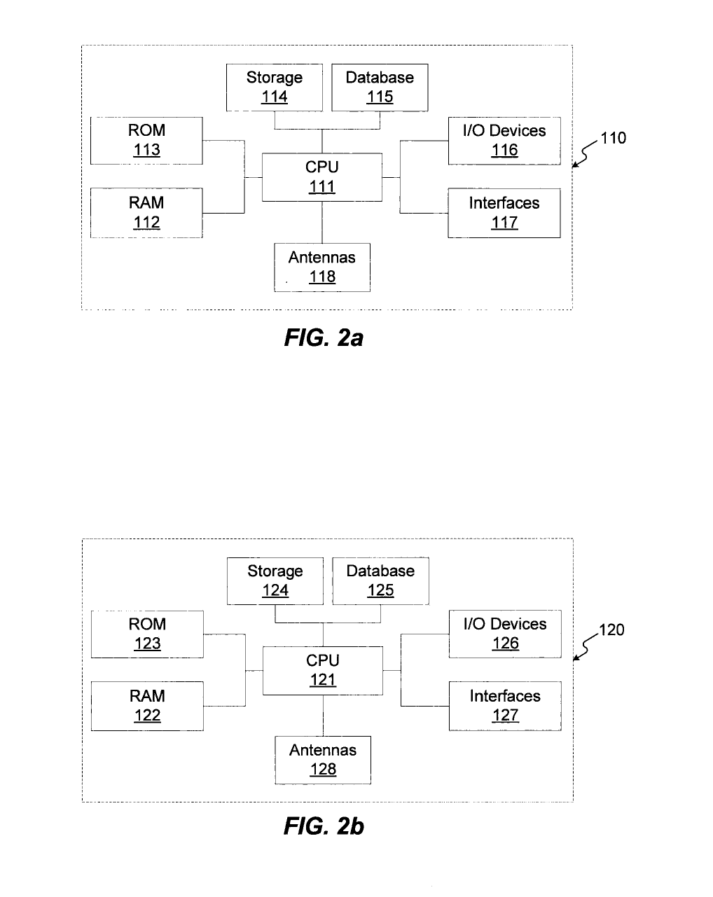

FIG. 2a is a diagram of an exemplary BS 110, consistent with certain disclosed embodiments. As shown in FIG. 2a, each BS 110 may include one or more of the following components: at least one central processing unit (CPU) 111 (also referred to herein as a processor) configured to execute computer program instructions to perform various processes and methods, random access memory (RAM) 112 and read only memory (ROM) 113 configured to access and store information and computer program instructions, memory 114 to store data and information, databases 115 to store tables, lists, or other data structures, I/O devices 116, interfaces 117, antennas 118, etc. Each of these components is well-known in the art and will not be discussed further.

RD 120 may be any type of computing device configured to wirelessly transmit and/or receive data to and from BS 110 in wireless communication system 100. RD 120 may include, for example, servers, clients, desktop computers, laptop computers, network computers, workstations, personal digital assistants (PDA), tablet PCs, scanners, telephony devices, pagers, cameras, musical devices, etc. In addition, RD 120 may include one or more wireless sensors in a wireless sensor network configured to communicate by means of centralized and/or distributed communication. In one exemplary embodiment, RD 120 may be a mobile computing device. In another exemplary embodiment, RD 120 may be a fixed computing device operating in a mobile environment, such as, for example, a bus, a train, an airplane, a boat, a car, etc.

FIG. 2b is a diagram of an exemplary RD 120, consistent with certain disclosed embodiments. As shown in FIG. 2b, each RD 120 may include one or more of the following components: at least one central processing unit (CPU) 121 (also referred to herein as a processor) configured to execute computer program instructions to perform various processes and methods, random access memory (RAM) 122 and read only memory (ROM) 123 configured to access and store information and computer program instructions, memory 124 to store data and information, databases 125 to store tables, lists, or other data structures, I/O devices 126, interfaces 127, antennas 128, etc. Each of these components is well-known in the art and will not be discussed further.

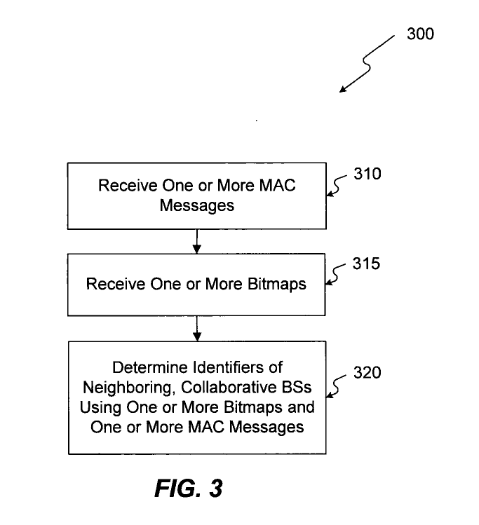

FIG. 3 is an exemplary flowchart 300 illustrating MIMO data transmission in a wireless communication system, such as wireless communication system 100, consistent with certain disclosed embodiments. Specifically, FIG. 3 illustrates an embodiment in which a serving BS 110, e.g., BS 110a of FIG. 1b, communicates information to one or more RDs 120, e.g., RDs 120a and 120b of FIG. 1b, where the information may be used to identify one or more neighboring BSs 110, e.g., BSs 110b and 110c, that may participate in MU-MIMO and, in particular, CO-MIMO, communications. BS 110 may be considered to be the serving BS 110 to one or more RDs 120 when it is the primary physical unit by which the one or more RDs 120 may communicate with wireless communication system 100. In some embodiments, the serving BS 110 may change over time for any given RD 120 as, for example, may happen when a mobile RD 120 moves from within a broadcast/reception range serviced by one BS 110 to a broadcast/reception range serviced by another BS 110. In other embodiments, the embodiment illustrated in FIG. 3 may be implemented by a central control unit corresponding to a plurality of BSs 110. To enable MU-MIMO and, in particular, CO-MIMO, RD 120 may be required to identify the one or more BSs 110, e.g., BS 110b and BS 110c, that neighbor serving BS 110a. In some embodiments, RD 120 may be instructed by serving BS 110a to acquire information to identify the neighboring BSs 110.

As shown in FIG. 3, RD 120 may receive one or more media access control (MAC) messages from serving BS 110a (310). The one or more MAC messages may include, for example, information related to one or more neighboring collaborative and/or non-collaborative BSs 110. The received one or more MAC messages may be stored in, for example, RAM 122, ROM 123, and/or storage 124. The one or more MAC messages may include a mapping, referred to as a bitmap, between a bit index received from serving BS 110a and identifiers associated with one or more neighboring BSs 110. In some embodiments, each of the identifiers associated with the one or more neighboring BSs 110 may be a BS Identifier (BSID). While the mapping in the bitmap may be determined by either BS 110a or RD 120, the bitmap may be identical between serving BS 110a and RD 120. In some embodiments, when RD 120 determines that it desires to participate in collaborative communication, RD 120 may send one or more feedback messages to BS 110a to indicate its desire for collaborative communication.

In response to the one or more feedback messages sent to BS 110a, RD 120 may receive one or more bitmaps from serving BS 110 (315). The one or more bitmaps may be sent to RD 120 from serving BS 110 in the form of one or more MAC messages. Each bit in the one or more bitmaps may represent one BS 110, and may serve as a bit index into a bitmap to allow RD 120 to identify the BS 110. That is, using the bits of the received one or more bitmaps as indices into the bitmap, RD 120 may determine the identifiers associated with one or more neighboring collaborative BSs 110 (320). For example, in some embodiments, an i^{th} bit of the one or more bitmaps may be set to 0 if the associated BS 110 is collaborative, and set to 1 if the associated BS 110 is non-collaborative. In other embodiments, the ^{ith} bit of the one or more bitmaps may be set to 1 if the associated BS 110 is collaborative, and set to 0 if the associated BS 110 is non-collaborative. In embodiments where the one or more bitmaps size is fixed (e.g., n bits) and is smaller than the number of candidates listed in the MAC message, only n candidates with the highest utility function (e.g., channel strength) may be indicated in the one or more bitmaps. The sizes of the one or more bitmaps may be either constant or variable.

In some embodiments, the identifiers associated with one or more neighboring BSs 110 in the bitmap may be ordered based on a channel strength between each BS 110 and RD 120 (e.g., channel strength between BS 110a and RD 120, channel strength between BS 110b and RD 120, channel strength between BS 110c and RD 120, etc.). For example, the bitmap may list the identifiers associated with one or more neighboring BSs 110 in a decreasing order from the BS 110 having a greatest channel strength to RD 120 to the BS 110 having a least channel strength to RD 120. Thus, the i^{th} bit in a bitmap may identify a BS 110 having an i^{th} greatest channel strength to RD 120 in the bitmap.

Because an identifier associated with a BS 110 may be a long bitmap, the bitmap embodiment illustrated by FIG. 3 may allow wireless communication system 100 to reduce the transmission overhead associated with the transmission of large amounts of data. The reduction of transmission overhead may be particularly beneficial when the number of collaborative BSs 110 is large.

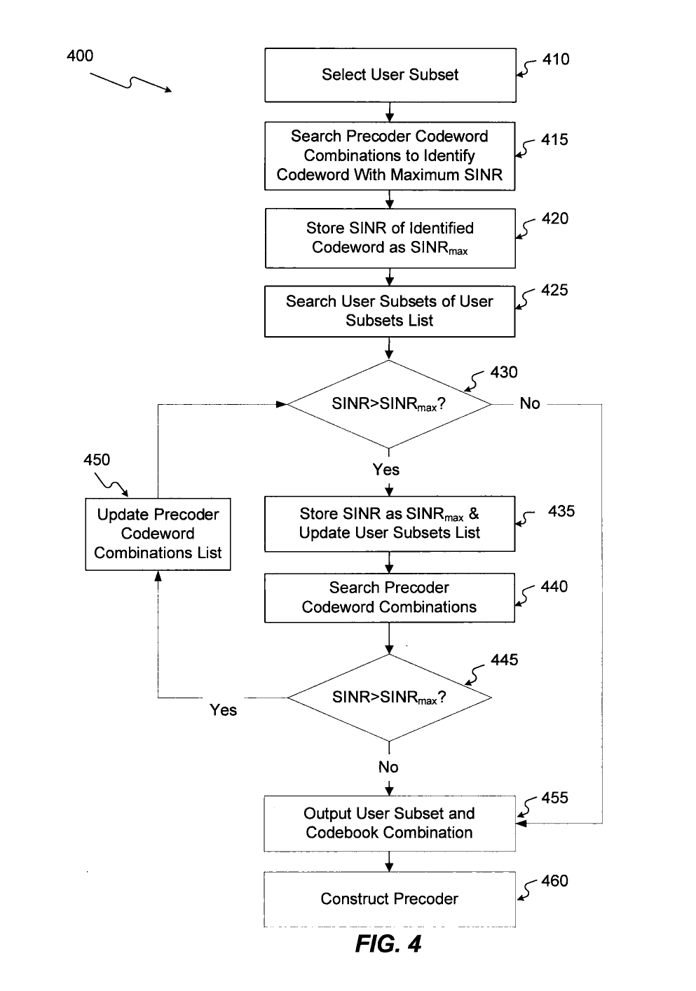

FIG. 4 is an exemplary flowchart 400 illustrating a user and precoder selection algorithm in a wireless communication system, such as wireless communication system 100, consistent with certain disclosed embodiments. The embodiment of FIG. 4 may be utilized when, for example, multiple users are served in the same resource unit via beamforming techniques. Generally, beamforming is a technique used for directional signal transmission and/or reception. During signal transmission, for example, using beamforming techniques, BS 110 may control the phase and relative amplitude of the signal at each transmitter, e.g., antennas 118, to create a pattern of constructive and destructive interference. During signal reception, the information transmitted from different transmitters may be combined by RD 120 so that the expected pattern of radiation is preferentially observed. In some embodiments, the embodiment illustrated in FIG. 4 may be implemented by a central control unit corresponding to a plurality of BSs 110.

In the embodiment illustrated by FIG. 4, serving BS 110 may generate one or more precoders based on channel-related information associated with a subset of RDs 120. The channel-related information may be transmitted to BS 110 from RD 120 via one or more feedback links. The channel-related information may include, for example, channel structure, sum rate, measured signal strength, channel quality indicator (CQI), signal-to-noise ratio (SNR), signal to interference plus noise ratio (SINR), bit error rate (BER), block error rate (BLER), packet error rate, etc. In some embodiments, the one or more precoders may be generated based on a desire to maximize the resultant SINR. In other embodiments, the one or more precoders may be generated based on a desire to improve other channel-related information, including channel structure, measured signal strength, CQI, BER, BLER, packet error rate, etc.

The one or more precoders Wₖ may be constructed according to Equation 1, as follows:

Wₖ=[w₁ w₂ . . . w_{Nt}] Equation 1
wherein k=0, 1, 2, 3 . . . , M−1.

In Equation 1, M is the number of collaborative neighboring BSs 110 (e.g., BS 110b and BS 110c of FIG. 1b), Nt is the number of transmission antennas at a single BS 110 (e.g., 2 antennas at BS 110a in FIG. 1b), and w₁, w₂, . . . w_{Nt} are the matrices (or vectors) chosen from a codebook, where the number of matrices available in the codebook is denoted as C. In some embodiments, the codebook may be predetermined.

In the embodiment illustrated by FIG. 4, serving BS 110, e.g., BS 110a of FIG. 1b, may provide lists of all possible user subsets and precoder codebook subsets. For example, serving BS 110 may select a subset of RDs 120 out of the total number of RDs 120 within the broadcast/reception range of serving BS 110. In embodiments having a single BS 110, each user subset may have Nt users, each precoder codebook subset may consist of Nt vectors, and each vector may have a dimension of Nt×1. In embodiments having multiple collaborative BSs 110 M, each user subset may have Nt users, each precoder codebook subset may consist of M.Nt vectors, and each vector may have a dimension of Nt×1. As a result, one precoder codebook subset may have M matrices, each with a dimension of Nt×Nt.

Depending on the configuration of a wireless communication system, e.g., wireless communication system 100, a codeword type may be either a matrix or a vector. For example, in certain embodiments, each codeword in a precoder codebook subset may be a unitary matrix having a dimension of Nt×S (Nt≧S>1), where S is the number of users in each user subset and is the maximum number of users that can be scheduled in one resource unit. In such embodiments, when there are multiple BSs 110, the user and precoder selection algorithm of FIG. 4 may identify a codeword combination consisting of M codewords. When there is a single BS 110, the user and precoder selection algorithm of FIG. 4 may identify a codeword combination consisting of 1 codeword. In other words, the precoder matrix for each BS 110 may be directly identified as a codeword from the codebook rather than constructed using Nt individual vectors. In other embodiments, however, the codebook may be constructed using Nt individual vectors.

Once user subset and precoder codebook combinations lists are created, BS 110 may select one of the user subsets in the user subsets list (410), and search the precoder codebook combinations list to identify a user subset and codeword combination having a maximum SINR for the selected user subset (415). The SINR for the user subset and codeword combination may be calculated by BS 110. The SINR value associated with the identified codeword combination may be stored as SINRₘₐₓ (420).

Based on the identified codeword combination, BS 110 may search through the user subsets list to determine if there is a better match for the identified codeword combination (425). A user subset may be a better match if an SINR for the user subset and codeword combination is greater than SINRₘₐₓ. The SINR for the user subset and codeword combination may be calculated by BS 110. If a better match is not found (430, No), the identified user subset and codeword combination are output for scheduling and precoder construction according to Equation 1, as illustrated above (455). If a better match is found (430, Yes), the SINR associated with the better match is stored as SINRₘₐₓ and the user subsets list is updated (435). In some embodiments, the user subsets list may be updated by removing the user subset identified in 410 from the user subsets list.

Based on the user subset identified in 435, the precoder codeword combinations list may be searched to determine if there is a codeword combination that is a better match (440). A codeword may be a better match if the SINR associated with the user subset and codeword combination is greater than SINRₘₐₓ. The SINR for the user subset and codeword combination may be calculated by BS 110. If a better match is not found in the precoder codeword combinations list (445, No), the previously identified user subset and codeword combination are output for scheduling and precoder construction according to Equation 1, as illustrated above (455). If a better match is found (445, Yes), the SINR associated with the user subset and codeword combination is stored as SINRₘₐₓ, and the precoder codeword combinations list is updated (450). In some embodiments, the precoder codeword combinations list may be updated by removing the codeword combination identified in 440 from the precoder codeword combinations list.

The process illustrated by flowchart 400 of FIG. 4 may continue through 430, 435, 440, 445, and 450 until a better match cannot be found, at which point the last identified user subset and codeword combination are output for scheduling and precoder construction according to Equation 1, as illustrated above (455). In some embodiments, however, BS 110 may determine a maximum number of comparison to be performed in the embodiment of FIG. 4. As a result, when the maximum number of comparisons is made, the process illustrated by FIG. 4 may be configured to terminate and the last identified user subset and codeword combination are output (455), and the output user subset and codeword combination may be used for precoder construction according to Equation 1, as illustrated above (460).

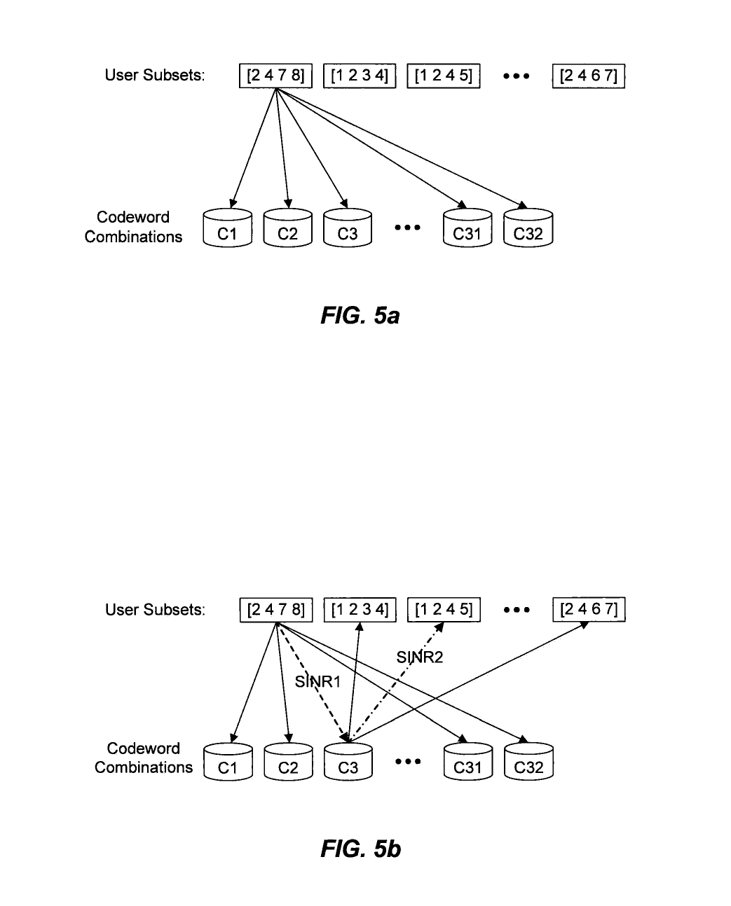

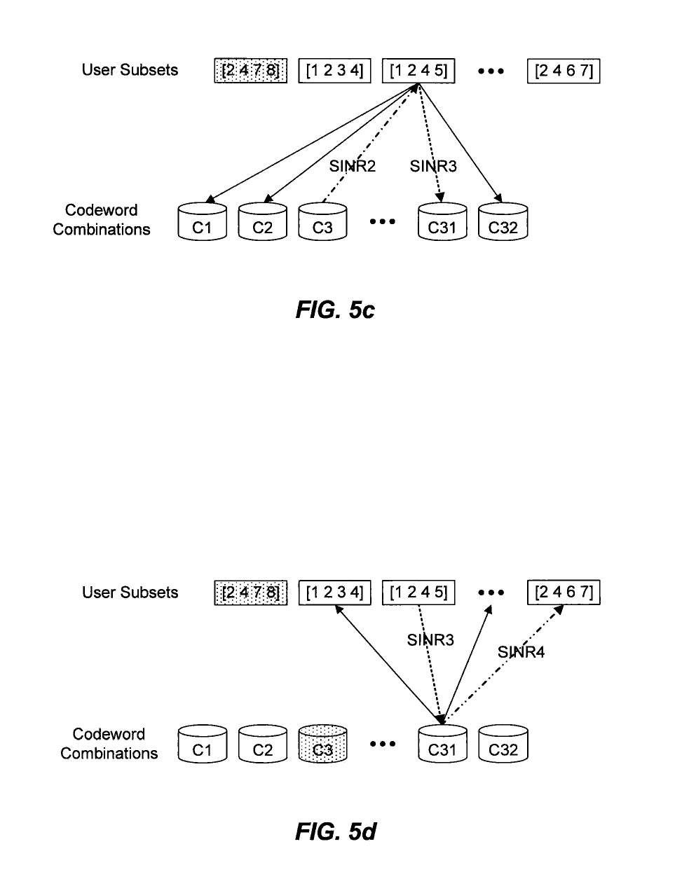

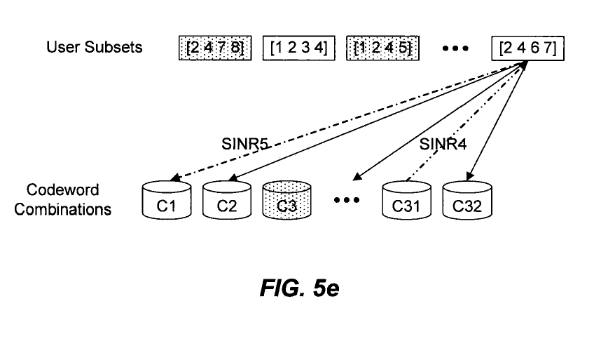

FIGS. 5a-5e illustrate an example of MIMO data transmission in a wireless communication system, such as wireless communication system 100, consistent with certain disclosed embodiments. In particular, FIGS. 5a-5e illustrate the embodiment disclosed in flowchart 400 of FIG. 4. In the embodiment illustrated in FIGS. 5a-5e, the number of users U in the subset of users is 8 and the number of codeword combinations is 32.

Referring to FIG. 5a, user subset [2 4 7 8] may be selected (410 of FIG. 4), and each codeword combination in the precoder codeword combinations list may be searched to identify a user subset and codeword combination having a maximum SINR (415 of FIG. 4). The SINR for the user subset and codeword combination may be calculated by BS 110. As shown in FIG. 5b, SINR1 of codeword combination C3 may be identified as the maximum SINR, and SINR1 may be stored as SINRₘₐₓ (420 of FIG. 4).

Using codeword combination C3, the user subsets list may be searched to determine if there is user subset having an SINR greater than the stored SINRₘₐₓ (425 of FIG. 4). The SINR for the user subset and codeword combination may be calculated by BS 110. In the example of FIG. 5b, SINR2 of user subset [1 2 4 5] is determined to be greater than SINRₘₐₓ (430, Yes of FIG. 4). Consequently, SINR2 is stored as SINRₘₐₓ and the user subsets list is updated (435 of FIG. 4). As discussed above in connection with FIG. 4, the user subsets list may be updated by removing the previously-identified user subset, i.e., user subset [2 4 7 8], from the user subsets list. The removal of user subset [2 4 7 8] from the user subsets list is illustrated in FIGS. 5c, 5d, and 5e by the dotted filling over user subset [2 4 7 8].

Next, referring to FIG. 5c, the codeword combinations of the precoder codeword combinations list may be searched to determine if there is a codeword combination having an SINR greater than the stored SINRₘₐₓ (440 of FIG. 4). The SINR for the user subset and codeword combination may be calculated by BS 110. In the example of FIG. 5c, SINR3 of codeword combination C31 is determined to be greater than SINRₘₐₓ (445, Yes of FIG. 4). Consequently, SINR3 is stored as SINRₘₐₓ and the precoder codeword combinations list is updated (450 of FIG. 4). As discussed above in connection with FIG. 4, the precoder codeword combinations list may be updated by removing the previously-identified codeword combination, i.e., codeword combination C3, from the precoder codeword combinations list. The removal of codeword combination C3 from the precoder codeword combinations list is illustrated in FIGS. 5d and 5e by the dotted filling over codeword combination C3.

In FIG. 5d, the process illustrated in FIG. 5b is repeated. That is, using codeword combination C31, the user subsets list may be searched to determine if there is a user subset having an SINR greater than the stored SINRₘₐₓ (425 of FIG. 4). The SINR for the user subset and codeword combination may be calculated by BS 110. In the example of FIG. 5d, SINR4 of user subset [2 4 6 7] is determined to be greater than SINRₘₐₓ (430, Yes of FIG. 4). Consequently, SINR4 is stored as SINRₘₐₓ, and the user subsets list is updated (435 of FIG. 4). As discussed above in connection with FIG. 4, the user subsets list may be updated by removing the previously-identified user subset, i.e., user subset [1 2 4 5], from the user subsets list. The removal of user subset [1 2 4 5] from the user subsets list is illustrated in FIG. 5e by the dotted filling over user subset [1 2 4 5].

Similarly, FIG. 5e repeats the process illustrated in FIG. 5c. As shown in FIG. 5e, the precoder codeword combinations list may be searched to determine if there is codeword combination having an SINR greater than the stored SINRₘₐₓ (440 of FIG. 4). The SINR for the user subset and codeword combination may be calculated by BS 110. In the example of FIG. 5e, SINR5 of codebook subset C1 is determined to be greater than SINRₘₐₓ (445, Yes of FIG. 4). Consequently, SINR5 is stored as SINRₘₐₓ and the precoder codeword combinations list is updated (450 of FIG. 4). As discussed above in connection with FIG. 4, the precoder codeword combinations list may be updated by removing the previously-identified codeword combination, i.e., codeword combination C31, from the precoder codeword combinations list.

As with flowchart 400 of FIG. 4, the process illustrated by FIGS. 5a-5e may continue until a better match cannot be found, at which point the last identified user subset and codeword combination are output for scheduling and precoder construction according to Equation 1, above (455 of FIG. 4). As discussed above in connection with FIG. 4, in some embodiments, BS 110 may determine a maximum number of comparisons to be performed. As a result, when the maximum number of comparisons is performed, the process illustrated by FIGS. 4 and 5 may be configured to terminate and the last identified user subset and codeword combination are output for scheduling and precoder construction according to Equation 1 above (455).

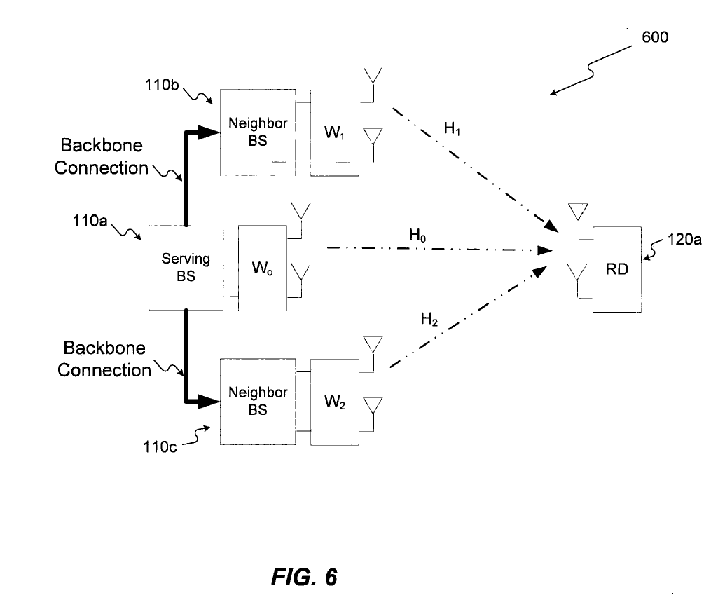

FIG. 6 is a diagram of an exemplary MIMO wireless communication system 600, consistent with certain disclosed embodiments. Similarly to FIGS. 1a and 1b, wireless communication system 600 of FIG. 6, may include one or more BSs 110, e.g., BS 110a, BS 110b, and BS 110c, and one or more RDs 120, e.g., RD 120a. As discussed above in connection with FIGS. 1a, 1b, and 2a, BS 110 may be any type of communication device configured to transmit and/or receive data and/or communications to and from one or more RDs 120 in wireless communication system 600, many of which are known in the art. Similarly, as discussed above in connection with FIGS. 1a, 1b, and 2b, RD 120 may be any type of computing device configured to wirelessly transmit and/or receive data to and from BS 110 in wireless communication system 600. In the embodiment of FIG. 6, wireless communication system 100 is a MU-MIMO wireless communication system in which multiple RDs 120 are concurrently served in the same time-frequency resource block (i.e., CO-MIMO).

In the embodiment of FIG. 6, multiple transmission nodes (e.g., BSs 110) may transmit the same data signal to a single reception node (e.g., RD 120a), a technique known as transmit macro-diversity. In an embodiment having closed-loop macro-diversity (CL-MD) with codebook-based precoders, RD 120a may search for a preferred precoder corresponding to each BS 110 based on a prevailing channel state. In other words, if there are M transmission nodes (e.g., BSs 110) involved in a collaboration, RD 120a may search for the best combination of M precoder indices. As used in FIG. 6, the codebook size is represented by C, and the index count is 1, 2, . . . C. A precoder constructed using M precoder indices may be referred to as a concatenating precoder.

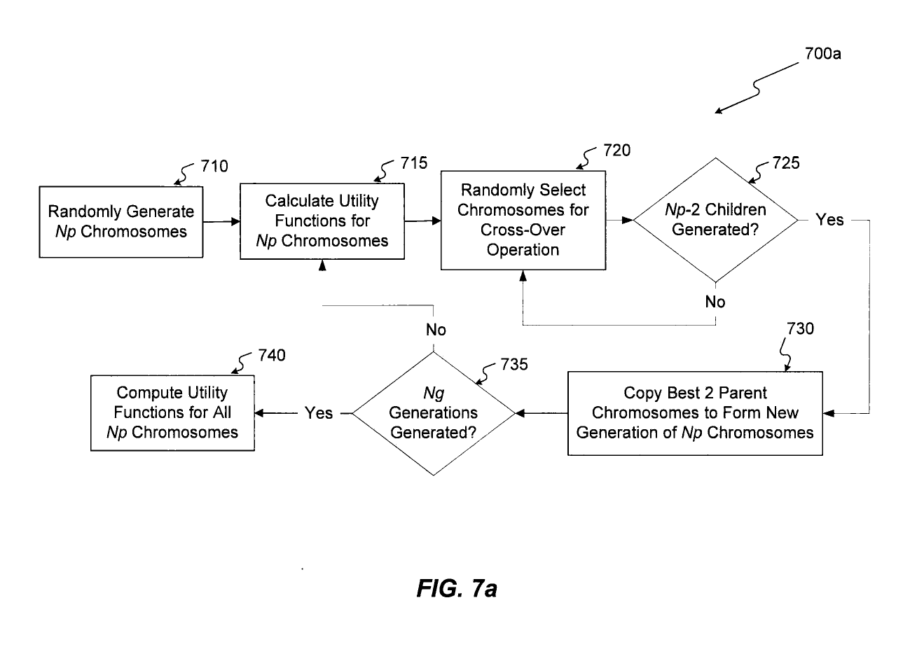

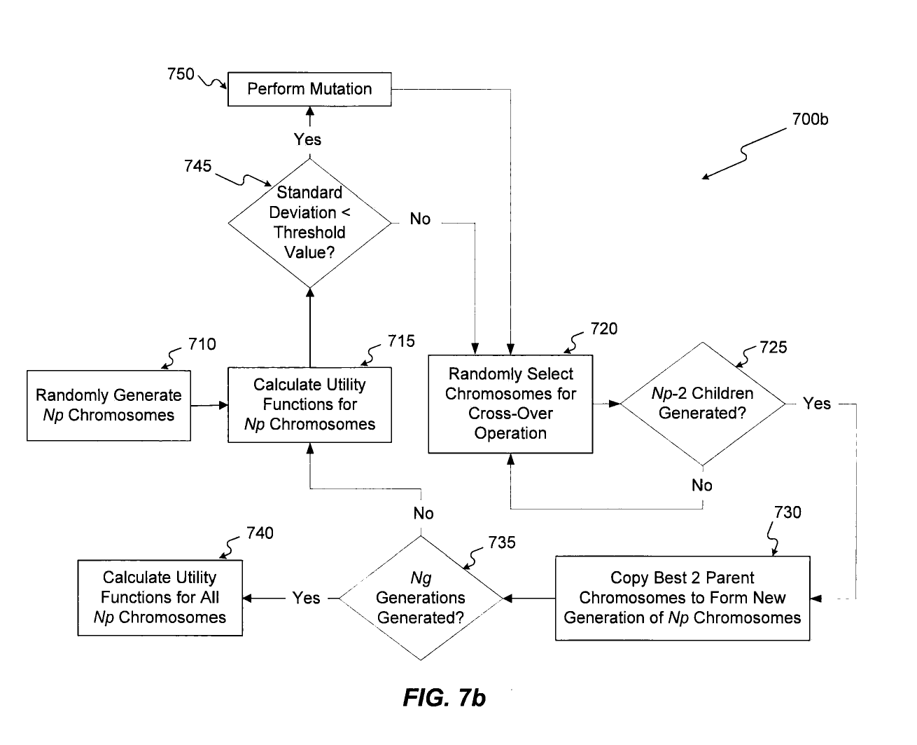

Flowchart 700a of FIG. 7a and flowchart 700b of FIG. 7b illustrate exemplary MIMO data transmissions in a wireless communication system, such as wireless communication system 600 of FIG. 6, consistent with certain disclosed embodiments. In the embodiments illustrated by FIGS. 7a and 7b, precoder indices may be searched based on so-called genetic algorithms, where each possible precoder index is encoded into a binary bit stream, referred to herein as a “chromosome.” In some embodiments, a chromosome may be constructed by cascading binary precoder indices for all transmission nodes involved in a collaboration (e.g., BSs 100a, 110b, and 110c of FIG. 6).

Referring, for example, to wireless communication system 600 of FIG. 6, when the number of transmission nodes involved in a collaboration M is equal to 3, and the codebook size C is equal to 64, each precoder index may be 6 bits, and the chromosome may be 18 bits. Thus, in an example where the precoder index for BS0 is 100011, the precoder index for BS1 is 011010, and the precoder index for BS2 is 001100, the resulting chromosome is 100011011010001100. The resulting chromosome may be used to determine a best combination of precoders that may be used to maximize performance of wireless communication systems, such as wireless communication system 600 of FIG. 6, as illustrated in greater detail in connection with FIGS. 7a and 7b.

Referring first to flowchart 700a of FIG. 7a, a reception node, e.g., RD 120a, may randomly generate Np chromosomes (710). Np may be an integer representing a number of chromosomes in a population. In some embodiments, Np may be a predefined constant integer. Next, RD 120a may compute a utility function associated with each of the generated Np chromosomes (715). The utility function may be used to indicate a “fitness” of an associated chromosome. The utility function may be, for example, an SNR value calculated according to Equation 2, below.

$$S N R = \frac{{‖ {H}_{c} {W}_{c} ‖}^{2} P}{{δ}^{2}} \qquad Equation 2$$

wherein
   H_{c}=[H₀H₁ . . . H_{M-1}] is the virtual combined channel of all transmission nodes;
   Hᵢ denotes the channel of the (i+1)-th transmission node;

$${W}_{c} = [ \begin{matrix}{W}_{0} \\ {W}_{1} \\ ⋮ \\ {W}_{M - 1}\end{matrix} ] is the concatenating precoder for all transmission nodes ;$$

Wᵢ is the precoder used at (i+1)-th transmission node;
P is the total transmission power at a receiving device; and
δ² is the total noise power at the receiver device.

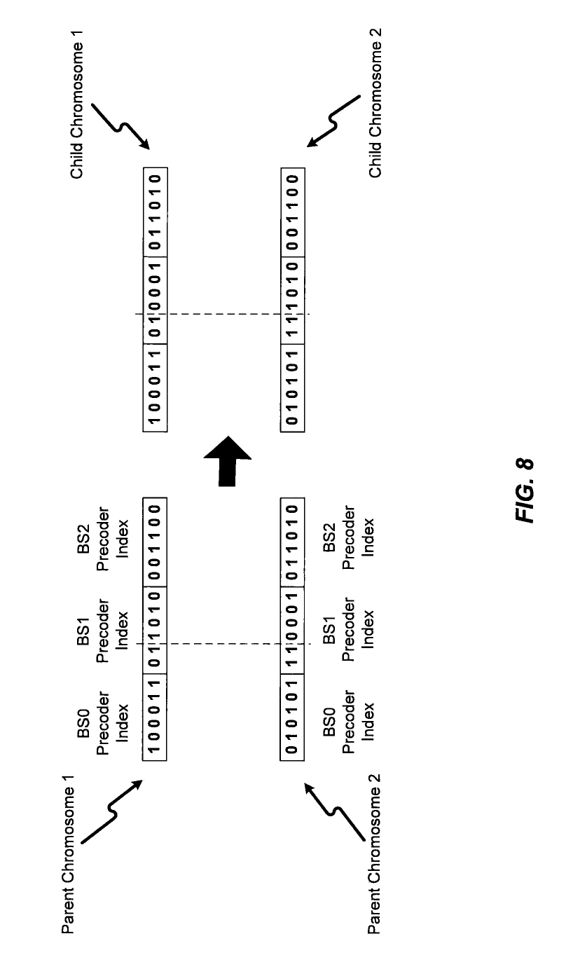

RD 120a may randomly select two chromosomes, referred to as parent chromosomes, from among the randomly generated Np chromosomes to perform cross-over operations (720). The cross-over operations may be performed to generate two new chromosomes, referred to as child chromosomes. In FIG. 8, which illustrates an exemplary cross-over operation, the parent chromosomes are identified as Parent Chromosome 1 and Parent Chromosome 2, and the child chromosomes are identified as Child Chromosome 1 and Child Chromosome 2.

Cross-over operations may be performed, for example, by exchanging bits between the parent chromosomes at a cross-over point. The cross-over point may be randomly chosen or may be predetermined. In the embodiment of FIG. 8, the cross-over point, illustrated by a vertical broken line, may be between the 8^{th} and 9^{th} bits of Parent Chromosome 1 and Parent Chromosome 2. Thus, the 9^{th} through 18^{th} bits of Parent Chromosome 1, i.e., 1010001100, may be exchanged with the 9^{th} through 18^{th} bits of Parent Chromosome 2, i.e., 0001011010, resulting in two child chromosomes, i.e., Child Chromosome 1 having a bit stream of 100011010001011010, and Child Chromosome 2 having a bit stream of 010101111010001100.

RD 120a may perform a check to determine if Np−2 child chromosomes have been successfully generated (725). If Np−2 child chromosomes are not generated (725, No), RD 120a may return to 720, discussed above, and again randomly select two parent chromosomes to perform cross-over operations.

When Np−2 children chromosomes are successfully generated (725, Yes), RD 120a may identify two parent chromosomes of the previous generation that have a best fitness using the utility function of Equation 2 above, and copy the determined parent chromosomes to obtain a new generation of chromosomes (730). In addition, the utility function of every member of the new generation of chromosomes may be calculated.

RD 120a may perform a check to determine if Ng generations of child chromosomes have been generated (735). Ng may be an integer representing a number of generations of chromosomes in a population. In some embodiments, Ng may be a predefined constant integer. If Ng generations are not generated (735, No), RD 120a may return to 715, discussed above. When Ng generations are generated (735, Yes), RD 120a may calculate the utility function for each of the chromosomes in the generated Ng generation, according to Equation 2 above (740).

As with FIG. 7a, FIG. 7b illustrates an embodiment in which precoder indices are searched based on genetic algorithms. Elements 710, 715, 720, 725, 730, 735, and 740 of flowchart 700b may be similar to elements 710, 715, 720, 725, 730, 735, and 740, respectively, of flowchart 700a. However, as shown in flowchart 700b, RD 120a may optionally perform a “mutation” operation, as shown in elements 745 and 750.

That is, once the utility function for each of the generated Np chromosomes has been calculated (715), a standard deviation may be compared to a threshold value to determine if mutation is desired (745). For example, if Np is 10 chromosomes, the utility function associated with each of the 10 chromosomes is determined, and the standard deviation of these 10 utility functions is calculated. In certain embodiments, RD 120a may compare the standard deviation of the best D solutions to the threshold value. In some embodiments, the threshold value may be a predetermined value. If the standard deviation is greater than or equal to the threshold value, RD 120a may randomly select two chromosomes to perform cross-over operations (720), and the process may continue as discussed above in connection with FIG. 7a.

If the standard deviation is less than the threshold value, RD 120a may perform mutation on each of the generated Np chromosomes (750). In performing mutation, RD 120a may randomly select bits in each of the generated Np chromosomes, and toggle the selected bits (e.g., 0 becomes 1, 1 becomes 0). Once mutation is complete, RD 120a may randomly select two chromosomes to perform cross-over operations (720), and the process may continue as discussed above in connection with FIG. 7a.

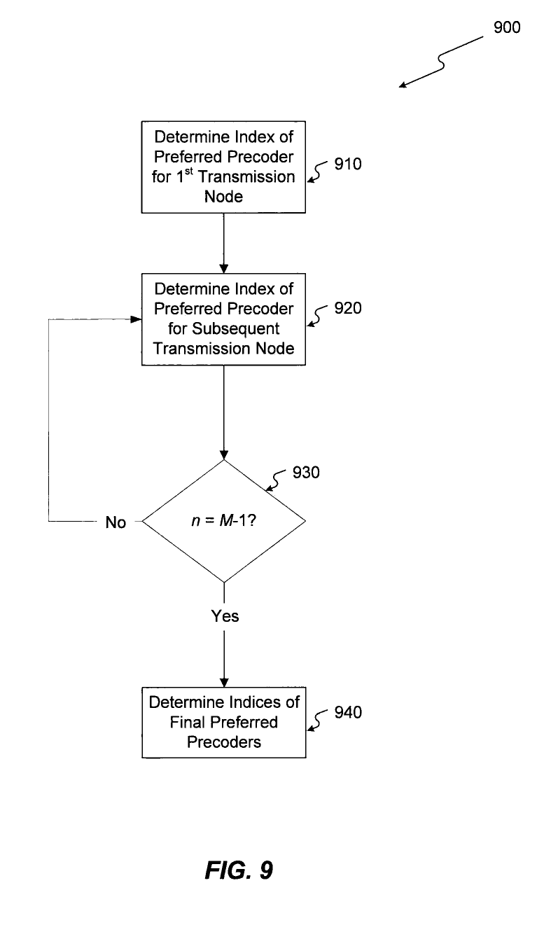

FIG. 9 is an exemplary flowchart 900 illustrating MIMO data transmission in a wireless communication system, such as wireless communication system 600 of FIG. 6, consistent with certain disclosed embodiments. The embodiment illustrated by FIG. 9 may be referred to as a “greedy” algorithm, i.e., a computational method that optimizes a problem by iteratively trying to improve a candidate solution with regard to a given measure of quality by making the locally optimal choice at each stage of the computation to find the globally optimal choice.

Using the virtual channel of the first transmission node, an index to a preferred precoder for the first transmission node may be determined (910). In some embodiments, the preferred precoder index may be determined using a utility function similar to the utility function of Equation 2. In the embodiment of FIG. 9, the preferred precoder index for the first transmission node may be calculated by Equation 3 as follows.

$${j}_{0}^{*} = {arg max}_{j} {‖ {H}_{0} {W}_{j} ‖}^{2} , \qquad Equation 3$$

where
   j*ₙ, n=0,1, . . . , M−1, is the preferred precoder index for (n+1)-th transmission node; and
   Wⱼ is the j-th codeword in the precoder codebook
   (j=1,2, . . . , C).

Using the virtual channel of the first transmission node in addition to a virtual channel of a subsequent transmission node, a preferred precoder index for the subsequent transmission node may be determined (920). In other words, when determining the preferred precoder index for the subsequent transmission node, the virtual channel may be extended by cascading its channel while preserving the precoders that have been determined in one or more previous iterations. Thus, the preferred precoder index for the subsequent transmission node (i.e., second transmission node) may be determined by calculating a precoder index as illustrated by Equation 4 as follows.

$${j}_{1}^{*} = {arg max}_{j} {‖ [ \begin{matrix}{H}_{0} & {H}_{1}\end{matrix} ] [ \begin{matrix}{W}_{{j}_{n}^{*}} \\ {W}_{j}\end{matrix} ] ‖}^{2} \qquad Equation 4$$

If n<M−1 (930, No), the process may return to 920 and a preferred precoder index for additional one or more subsequent transmission nodes may be determined until n=M−1. The preferred precoder indices for the one or more subsequent transmission nodes may be determined by calculating precoder indices as illustrated by Equation 5 as follows.

$${j}_{n}^{*} = {arg max}_{j} {‖ [ \begin{matrix}{H}_{0} & {H}_{1} & … & {H}_{n}\end{matrix} ] [ \begin{matrix}{W}_{{j}_{0}^{*}} \\ {W}_{{j}_{1}^{*}} \\ ⋮ \\ {W}_{j}\end{matrix} ] ‖}^{2} \qquad Equation 5$$

When n=M−1 (930, Yes), the full virtual channel may have been considered and the final precoders may be determined (940). In one exemplary embodiment, the determined final precoders may be precoders W_{j*}_{₀}, W_{j*}_{₁}, . . . , W_{j*}_{_{M-1}}. The embodiment of FIG. 9 may be referred to as an M-stage process. That is, the precoder for a first transmission node may be targeted in the first stage, the precoder for a second transmission node may be targeted in the second stage, and so on, until the precoders for all M transmission nodes are identified.

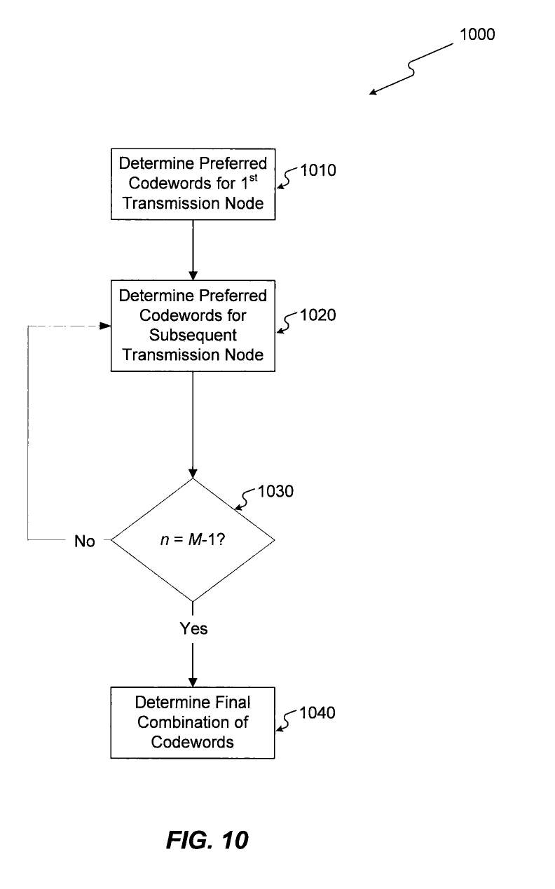

FIG. 10 is an exemplary diagram illustrating MIMO data transmission in a wireless communication system, such as wireless communication system 600 of FIG. 6, consistent with certain disclosed embodiments. In contrast to the embodiment disclosed in FIG. 9 in which only the best route at each stage is determined, the embodiment illustrated in FIG. 10 may select multiple candidate routes at every stage. That is, the embodiment illustrated in FIG. 10 may identify K candidates with the best utility functions in the first stage, and in subsequent stages, the embodiment illustrated in FIG. 10 may consider all possible solutions that extend from the K candidates in the previous stages. The embodiment illustrated in FIG. 10, referred to as a “K-Best Tree” precoder indices search, may be considered a variation of the embodiment disclosed in FIG. 9. That is, when K=1, the embodiment disclosed in FIG. 10 may be equivalent to the embodiment disclosed in FIG. 9.

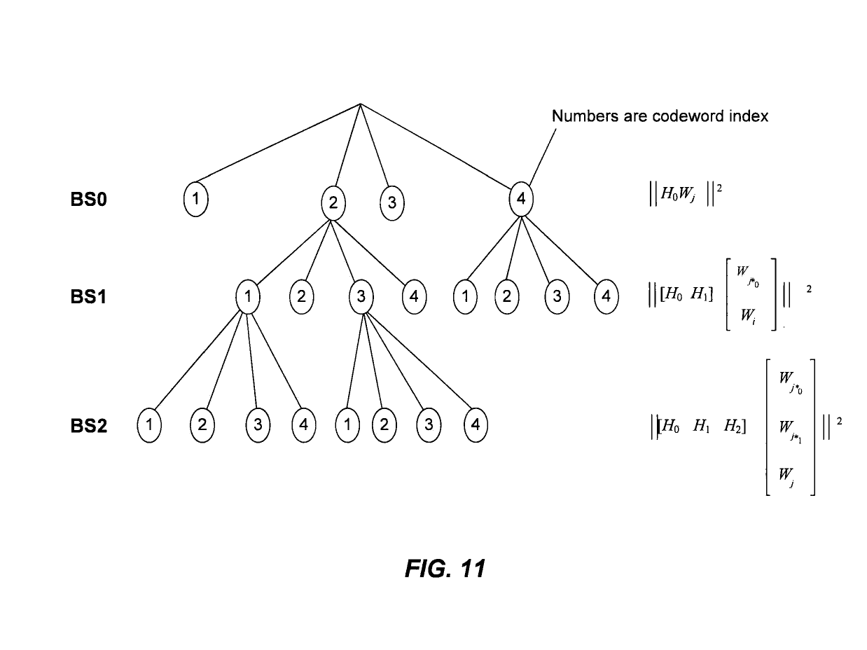

FIG. 11 is a diagram illustrating an embodiment of flowchart 1000 of FIG. 10. In the embodiment illustrated in FIG. 11, the number of codewords in the precoder codebook may be four (i.e., C=4), the number of candidates with the best utility function for each transmission node may be set to 2 (i.e., K=2), and the total number of transmission nodes may be 3 (i.e., M=3). Because the total number of transmission nodes is three, the embodiment of FIGS. 10 and 11 will terminate after three iterations.

Referring first to FIG. 10, using the virtual channel of the first transmission node, preferred codewords for the first transmission node may be determined (1010), i.e., BS0 codewords 2 and 4 of FIG. 11. The number of preferred codewords may be determined according to the value of K, e.g., K=2 as in FIG. 11. In some embodiments, the preferred codewords may be determined based on Equation 3, as discussed above. As shown in FIG. 11, the determined BS0 codewords may be 2 and 4 as the precoders associated with BS0 codeword indices may provide the best utility functions.

Referring again to FIG. 10, using the virtual channel of the first transmission node and a virtual channel of a subsequent transmission node, preferred codewords for the subsequent transmission node may be determined (1020). In some embodiments, the preferred codewords may be determined based on Equation 4, as discussed above. Thus, as shown in FIG. 11, the utility functions corresponding to BS0 codewords 2 and 4 may be evaluated, and two BS1 preferred codeword candidates for each of BS0 precoder indices 2 and 4 may be selected. In the example of FIG. 11, none of the branches extending from BS0 codeword 4 provide a better utility function than the two best branches extending from BS0 codeword 2, i.e., BS1 codewords 1 and 3, and processing proceeds through BS0 codeword 2. In other words, as illustrated in FIGS. 10 and 11, when determining preferred codewords for a subsequent transmission node, the virtual channel may be extended by cascading its channel while preserving the preferred codewords that have been determined in one or more previous iterations.

If n<M−1 (1030, No), preferred codewords for subsequent transmission nodes may be determined (1020), as according to Equation 5 above. If, however, n=M−1 (1030, Yes), the full virtual channel may be considered and the final combination of codewords may be selected (1040). Thus, as shown in FIG. 11, the utility functions corresponding to BS1 codewords 1 and 3 may be evaluated, and BS2 codewords for each of BS1 codewords 1 and 3 may be selected and compared to determine the best combination of codewords, i.e., best “path.” In the example of FIG. 11, the best utility function for BS1 codeword 1 is associated with BS2 codeword 4, and the best utility function BS1 codeword 3 is associated with BS2 codeword 1. When comparing BS2 codeword 4 and BS2 codeword 1, the best path may be determined to be {2,1,4}, which is output as the final combination of codewords. In other words, as illustrated in FIG. 11, BS0 codeword 2 may be chosen to be the precoder codeword for the first transmission node, BS1 codeword 1 may be chosen to be the precoder codeword for the second transmission node, and BS2 codeword 2 may be chosen to be the precoder codeword for the third transmission node.

While the embodiments disclosed herein refer to the 3GPP standards and technologies, the disclosed embodiments may also be used in wireless communications systems utilizing the Institute of Electrical and Electronics Engineers (IEEE) 802.16 family of standards and technologies. For example, the disclosed embodiments may also be used in a wireless communication system using Worldwide Interoperability for Microwave Access (WiMAX), which is promulgated by the WiMax Forum, and is based on the IEEE 802.16 family of standards and technologies.

The apparatuses and methods disclosed herein may be configured to prevent signals from different transmission nodes from being destructive to each other, thereby causing macro-diversity gain to be lost. In addition, the apparatuses and methods disclosed herein may reduce computational costs associated with more exhaustive search methods, and reduce the amount of feedback overhead. In this manner, the disclosed embodiments may reduce signal processing time and improve data traffic flow associated with signal transmission in any type of wireless network. Similarly, the methods and apparatus as described in connection with the disclosed embodiments may be configured to operate in any transmitting and/or receiving device.

It will be apparent to those skilled in the art that various modifications and variations can be made in the system and method for reception in communication networks. It is intended that the standard and examples be considered as exemplary only, with a true scope of the disclosed embodiments being indicated by the following claims and their equivalents.

What is claimed is:

1. A method for multi-input multi-output (MIMO) transmission in a wireless communication system including a plurality of base stations, comprising:
receiving, by a receiving device, one or more media access control (MAC) messages including a plurality of identifiers of neighboring base stations;
receiving, by the receiving device, a bitmap including a plurality of bits, each bit representing one base station of the plurality of base stations; and
determining, by the receiving device, at least one of the plurality of identifiers of neighboring base stations included in the one or more received MAC messages based on the received bitmap.

2. The method as in claim 1, further including:
identifying one or more collaborative base stations from the plurality of identifiers of neighboring base stations included in the one or more received MAC messages based on the received bitmap.

3. The method as in claim 1, further including:
determining a channel strength associated with each of the plurality of base stations and the receiving device.

4. The method as in claim 3, further including:
ordering the plurality of bits in the received bitmap according to a relative channel strength associated with the one base station of the plurality of base stations represented by each of the plurality of bits and the receiving device.

5. The method as in claim 4, wherein the ordering the plurality of bits in the received bitmap according to a relative channel strength further includes:
ordering the plurality of bits in the received bitmap according to a relative channel strength based on the determined channel strength.

6. An apparatus for multi-input multi-output (MIMO) transmission in a wireless communication system including a plurality of base stations, the apparatus comprising:
at least one memory to store data and instructions; and
at least one processor configured to access the at least one memory and, when executing the instructions, to:
receive one or more media access control (MAC) messages including a plurality of identifiers of neighboring base stations;
receive a bitmap including a plurality of bits, each bit representing one base station of the plurality of base stations; and
determine at least one of the plurality of identifiers of neighboring base stations included in the one or more received MAC messages based on the received bitmap.

7. The apparatus as in claim 6, wherein the at least one processor is further configured to:
identify one or more collaborative base stations from the plurality of identifiers of neighboring base stations included in the one or more received MAC messages based on the received bitmap.

8. The apparatus as in claim 6, wherein the at least one processor is further configured to:
determine a channel strength associated with each of the plurality of base stations and the apparatus.

9. The apparatus as in claim 8, wherein the at least one processor is further configured to:
order the plurality of bits in the received bitmap according to a relative channel strength associated with the one base station of the plurality of base stations represented by each of the plurality of bits and the receiving device.

10. The apparatus as in claim 9, wherein when the at least one processor is configured to order the plurality of bits in the received bitmap according to a relative channel strength, the at least one processor is further configured to:
order the plurality of bits in the received bitmap according to a relative channel strength based on the determined channel strength.

11. A method for multi-input multi-output (MIMO) transmission in a wireless communication system including a plurality of base stations, comprising:
determining, by one base station of the plurality of base stations, a user subset from a user subsets list;
searching, by the one base station, a codeword combinations list to identify a codeword combination having a desired signal-to-interference noise ratio (SINR) based on the determined user subset;
storing, by the one base station, the desired SINR as a maximum SINR (SINRₘₐₓ);
iteratively processing, by the one base station, at least one of the user subsets list and the codeword combinations list to identify a final user subset and final codeword combination;
outputting, by the one base station, the identified final user subset and the final codeword combination; and
constructing, by the one base station, a precoder based on the output final user subset and final codeword combination.

12. The method as in claim 11, wherein iteratively processing further includes:
searching, by the one base station, the user subsets list to identify a user subset having a second desired SINR based on the identified codeword combination; and
identifying, when the second desired SINR is not greater than the stored SINRₘₐₓ, the identified user subset and the identified codeword combination as the final user subset and the final codeword combination.

13. The method as in claim 12, further including:
storing, by the one base station, when the second desired SINR is greater than the stored SINRₘₐₓ, the second desired SINR as SINRₘₐₓ;
searching, by the one base station, the codeword combinations list to identify a second codeword combination having a third desired SINR based on the identified user subset; and
identifying, when the third desired SINR is not greater than the stored SINRₘₐₓ, the identified user subset and the identified codeword combination as the final user subset and the final codeword combination.

14. The method as in claim 13, wherein the storing the second desired SINR as a SINRₘₐₓ, further includes:
removing, by the one base station, the identified user subset from the user subsets list.

15. The method as in claim 11, wherein the storing the desired SINR as a SINRₘₐₓ, further includes:
removing, by the one base station, the identified codeword combination from the codeword combinations list.

16. The method as in claim 11, wherein the user subsets list includes a plurality of user subsets corresponding to at least one of the plurality of base stations.

17. The method as in claim 11, wherein the codeword combinations list includes a plurality of codeword combinations associated with a codebook.

18. The method as in claim 17, wherein the codebook is predetermined.

19. An apparatus for multi-input multi-output (MIMO) transmission in a wireless communication system including a plurality of base stations, the apparatus comprising:
at least one memory to store data and instructions; and
at least one processor configured to access the at least one memory and, when executing the instructions, to:
determine a user subset from a user subsets list;
search a codeword combinations list to identify a codeword combination having a first desired signal-to-interference noise ratio (SINR) based on the determined user subset;
store the first desired SINR as a maximum SINR (SINRₘₐₓ);
iteratively process at least one of the user subsets list and the codeword combinations list to identify a final user subset and final codeword combination;
output the identified final user subset and the final codeword combination; and
construct a precoder based on the output final user subset and final codeword combination.

20. The apparatus as in claim 19, wherein when the at least one processor is configured to iteratively process, the at least one processor is further configured to:
search the user subsets list to identify a user subset having a second desired SINR based on the identified codeword combination; and
identify, when the second desired SINR is not greater than the stored SINRₘₐₓ, the identified user subset and the identified codeword combination as the final user subset and the final codeword combination.

21. The apparatus as in claim 20, wherein at the least one processor is further configured to:
store, when the second desired SINR is greater than the stored SINRₘₐₓ, the second desired SINR as SINRₘₐₓ;
search the codeword combinations list to identify a second codeword combination having a third desired SINR based on the identified user subset; and
identify, when the third desired SINR is not greater than the stored SINRₘₐₓ, the identified user subset and the identified codeword combination as the final user subset and the final codeword combination.

22. The apparatus as in claim 21, wherein when the at least one processor is configured to store the second desired SINR as SINRₘₐₓ, the at least one processor is further configured to:
remove the identified user subset from the user subsets list.

23. The apparatus as in claim 19, wherein when the at least one processor is configured to store the desired SINR as a SINRₘₐₓ, the at least one processor is further configured to:
remove the identified codeword combination from the codeword combinations list.

24. The apparatus as in claim 19, wherein the user subsets list includes a plurality of user subsets corresponding to at least one of the plurality of base stations.

25. The apparatus as in claim 19, wherein the codeword combinations list includes a plurality of codeword combinations associated with a codebook.

26. The apparatus as in claim 25, wherein the codebook is predetermined.

27. A method for multi-input multi-output (MIMO) transmission in a wireless communication system including a plurality of base stations, comprising:
determining, by a receiving device, a number Ng of generation bit streams;
determining, by the receiving device, a number Np of population bit streams;
generating, by the receiving device, a plurality of parent bit streams;
iteratively processing, by the receiving device, through the plurality of parent bit streams for Ng times, including:
calculating, by the receiving device, a utility function associated with each of the plurality of parent bit streams,
iteratively processing, by the receiving device, through the plurality of parent bit streams for Np times, including:
selecting, by the receiving device, two bit streams of the plurality of parent bit streams, and
performing, by the receiving device, a cross-over operation based on the selected two bit streams to generate at least one child bit stream, and
identifying, by the receiving device, an additional two bit streams of the plurality of parent bit streams to form a plurality of next generation bit streams, and
calculating, by the receiving device, a utility function associated with each bit stream of the plurality of next generation bit streams;
identifying, by the receiving device, at least one bit stream of the plurality of next generation bit streams; and
performing, by the receiving device, a precoder search based on the at least one bit stream of the plurality of next generation bit streams.

28. The method as in claim 27, further including:
encoding, by the receiving device, a plurality of precoders corresponding to the plurality of base stations to generate the plurality of parent bit streams.

29. The method as in claim 27, further including:
determining, by the receiving device, after calculating the utility function associated with each of the plurality of parent bit streams, a standard deviation corresponding to the plurality of next generation bit streams.

30. The method as in claim 29, further including:
comparing, by the receiving device, the determined standard deviation to a threshold value;
selecting, by the receiving device, when the standard deviation is less than the threshold value, one or more bits of each of the plurality of parent bit streams; and
toggling, by the receiving device, the selected one or more bits.

31. An apparatus for multi-input multi-output (MIMO) transmission in a wireless communication system including a plurality of base stations, the apparatus comprising:
at least one memory to store data and instructions; and
at least one processor configured to access the at least one memory and, when executing the instructions, to:
determine a number Ng of generation bit streams;
determine a number Np of population bit streams;
generate a plurality of parent bit streams;
iteratively process through the plurality of parent bit streams for Ng times, including:
calculate a utility function associated with each of the plurality of parent bit streams,
iteratively process through the plurality of parent bit streams for Np times, including:
select two bit streams of the plurality of parent bit streams, and
perform a cross-over operation based on the selected two bit streams to generate at least one child bit stream, and
identify an additional two bit streams of the plurality of parent bit streams to form a plurality of next generation bit streams, and
calculate a utility function associated with each bit stream of the plurality of next generation bit streams;
identify at least one bit stream of the plurality of next generation bit streams; and
perform a precoder search based on the at least one bit stream of the plurality of next generation bit streams.

32. The apparatus as in claim 31, wherein the at least one processor is further configured to:
encode a plurality of precoders corresponding to the plurality of base stations to generate the plurality of parent bit streams.

33. The apparatus as in claim 31, wherein the at least one processor is further configured to:
determine, after calculating the utility function associated with each of the plurality of parent bit streams, a standard deviation corresponding to the plurality of next generation bit streams.

34. The apparatus as in claim 32, wherein the at least one processor is further configured to:
compare the determined standard deviation to a threshold value;
select, when the standard deviation is less than the threshold value, one or more bits of each of the plurality of parent bit streams; and
toggle the selected one or more bits.

35. A method for multi-input multi-output (MIMO) transmission in a wireless communication system including a plurality of base stations, comprising:
determining, by a receiving device, for a first base station of the plurality of base stations, a first plurality of candidate codewords included in a codebook;
determining, by the receiving device, a second plurality of candidate codewords for a second base station of the plurality of base stations based on the identified first plurality of codewords;
comparing, by the receiving device, the codewords in the second plurality of candidate codewords to identify one codeword of the first plurality of candidate codewords;
determining, by the receiving device, an updated second plurality of candidate codewords for the second base station based on the comparison of the codewords in the second plurality of candidate codewords;
determining, by the receiving device, a third plurality of candidate codewords for a third base station of the plurality of base stations based on the updated second plurality of codewords;
comparing, by the receiving device, the codewords in the third plurality of candidate codewords to identify one codeword of the second plurality of candidate codewords; and
determining, by the receiving device, a combination of precoder codewords based on the identified one codeword of the first plurality of candidate codewords and the identified one codeword of the second plurality of candidate codewords.

36. The method as in claim 35, further including:
determining, by the receiving device, an updated third plurality of candidate codewords for the third base station based on the comparison of the codewords in the third plurality of candidate codewords
determining, by the receiving device, a fourth plurality of candidate codewords for a fourth base station of the plurality of base stations based on the updated third plurality of codewords;
comparing, by the receiving device, the codewords in the fourth plurality of candidate codewords to identify one codeword of the third plurality of candidate codewords;
determining, by the receiving device, an updated fourth plurality of candidate codewords for the fourth base station based on the comparison of the codewords in the fourth plurality of candidate codewords; and
determining, by the receiving device, a combination of precoder codewords based on the identified one codeword of the first plurality of candidate codewords, the identified one codeword of the second plurality of candidate codewords, and the identified one codeword of the third plurality of candidate codewords.

37. The method as in claim 35, wherein the determining for the first base station the first plurality of candidate codewords further includes:
calculating, by the receiving device, a utility function for each of the plurality of codewords in the codebook; and
determining, by the receiving device, for the first base station, the first plurality of candidate codewords based on the calculated utility functions.

38. An apparatus for multi-input multi-output (MIMO) transmission in a wireless communication system including a plurality of base stations, the apparatus comprising:
at least one memory to store data and instructions; and
at least one processor configured to access the at least one memory and, when executing the instructions, to:
determine for a first base station of the plurality of base stations, a first plurality of candidate codewords included in a codebook;
determine a second plurality of candidate codewords for a second base station of the plurality of base stations based on the identified first plurality of codewords;
compare the codewords in the second plurality of candidate codewords to identify one codeword of the first plurality of candidate codewords;
determine an updated second plurality of candidate codewords for the second base station based on the comparison of the codewords in the second plurality of candidate codewords;
determine a third plurality of candidate codewords for a third base station of the plurality of base stations based on the updated second plurality of codewords;
compare the codewords in the third plurality of candidate codewords to identify one codeword of the second plurality of candidate codewords; and
determine a combination of precoder codewords based on the identified one codeword of the first plurality of candidate codewords and the identified one codeword of the second plurality of candidate codewords.

39. The apparatus as in claim 38, wherein the at least one processor is further configured to:
determine an updated third plurality of candidate codewords for the third base station based on the comparison of the codewords in the third plurality of candidate codewords;
determine a fourth plurality of candidate codewords for a fourth base station of the plurality of base stations based on the updated third plurality of codewords;
compare the codewords in the fourth plurality of candidate codewords to identify one codeword of the third plurality of candidate codewords;
determine an updated fourth plurality of candidate codewords for the fourth base station based on the comparison of the codewords in the fourth plurality of candidate codewords; and
determine a combination of precoder codewords based on the identified one codeword of the first plurality of candidate codewords, the identified one codeword of the second plurality of candidate codewords, and the identified one codeword of the third plurality of candidate codewords.

40. The apparatus as in claim 38, wherein when the at least one processor is further configured to determine for the first base station the first plurality of candidate codewords, the at least one processor is further configured to:
calculate a utility function for each of the plurality of codewords in the codebook; and
determine, for the first base station, the first plurality of candidate codewords based on the calculated utility functions.
